(19) United States
(12) Patent Application Publication
(10) Pub. No.: US 2013/0268320 A1
(43) Pub. Date: Oct. 10, 2013

(54) DEMAND PREDICTION SYSTEM

(71) Applicants: Naoya Kawamura, Minato-ku (JP); Koki Tateishi, Minato-ku (JP); Akihiro Sawanoi, Minato-ku (JP); Manabu Kasano, Minato-ku (JP); Yuichi Sasaki, Minato-ku (JP)

(72) Inventors: Naoya Kawamura, Minato-ku (JP); Koki Tateishi, Minato-ku (JP); Akihiro Sawanoi, Minato-ku (JP); Manabu Kasano, Minato-ku (JP); Yuichi Sasaki, Minato-ku (JP)

(73) Assignee: MITSUBISHI HEAVY INDUSTRIES, LTD., Tokyo (JP)

(21) Appl. No.: 13/882,206

(22) PCT Filed: Nov. 15, 2011
(86) PCT No.: PCT/JP2011/076245

§ 371 Date: Jun. 28, 2013

(30) Foreign Application Priority Data
Nov. 18, 2010 (JP) 2010-257417

(51) Int. Cl. G06Q 30/02

(52) U.S. Cl. CPC G06Q 30/0202
USPC 705/7.31

(57) ABSTRACT

In order to predict demand, in a demand prediction computing unit (100) a dealer demand prediction computing unit (200) predicts a demand for a dealer, a corporation demand prediction computing unit (300) predicts a demand for a corporation, and a totaling unit (400) totals the predicted demand for the dealer and the predicted demand for the corporation, predicting thereby an aggregate demand. The dealer demand prediction computing unit (200) takes the attribute of the dealer into account and predicts the demand, and the corporation demand prediction computing unit (300) takes the attribute of the corporation into account and predicts the demand. In this manner the attribute of a demander (customer) is taken into account and demand is predicted, and therefore the prediction accuracy is improved.

### TECHNICAL FIELD

The present invention relates to a demand prediction system and has been arranged so that demands can be predicted at high accuracy by predicting demands while taking attributes (for example, whether large customers, small customers, or customers of high or low prediction accuracy) of demanders (customers) into consideration.

### BACKGROUND ART

In manufacturing industries, manufacturers order many parts (including not only so-called “parts”, but also “in-process products”, “materials”, etc.) from parts suppliers and manufacture products by, for example, assembling the ordered parts.

For example, when forklifts are to be manufactured, manufactures predict medium- to long-term demands and make arrangements to, for example, order parts in accordance with the predictions, thereby making efforts to shorten the period from the point when orders for the products are received from demanders (persons who are to purchase the forklifts) to the point when the products are actually delivered to the demanders.

Conventional methods of predicting demands will be explained.

In major countries in the world, there are organizations (international organizations and associations) for industrial vehicles such as forklifts. For example, Japan Industrial Vehicle Association (JIVA) is present in Japan, Industrial Truck Association (ITA) is present in USA, British Industrial Truck Association (BITA) is present in UK, European Federation of Materials Handling (FEM) is present in Europe, and Korea Construction Equipment Manufacturers Association (KOCEMA) is present in South Korea.

Such organizations release demand prediction numbers of industrial vehicles of one year in the country in which the organizations are present or in the neighboring countries of the country.

For example, Industrial Truck Association (ITA) in USA releases the demand prediction numbers of industrial vehicles of one year in the countries of North America and South America at a frequency of several times a year.

When a certain manufacturer (which will be referred to as “Company A”) is to predict demands of Company A in USA, the demand prediction number of Company A has been obtained by multiplying the demand prediction number of industrial vehicles of one year in USA released by ITA by the share of Company A in USA.

However, even when the demands are predicted by multiplying the demand prediction number, which has been released by the organization as described above, by the share, accuracy of the obtained demand prediction has not been really good. This is because the demand prediction number released by the above described organization is rough, and, in addition, the method of predicting the demands by simply multiplying the demand prediction number by the share is inferior in terms of accuracy.

If a manufacturer manufactures forklifts based on the demand prediction of which accuracy is not really good in this manner, in some cases, parts become insufficient in a certain period, and parts become excessive in another period. Also, there has been problems that delivery of products to demanders (customers) is delayed and excessive cost is taken for management, etc. of excessive parts.

Furthermore, manufacturers have the sentiments that they want lacking parts immediately and that they do not want to keep excessive parts. Therefore, there have been situations on that an order is placed to make a part supplier deliver parts immediately when the parts are likely to become insufficient and that the part supplier is required to cancel or postpone delivery of parts when the parts are likely to become excessive.

If such situations occur frequently, the parts supplier sometimes cannot respond to the requests from the manufacturer, and there is a tendency that smooth delivery of parts from the parts supplier to the manufacturer is disturbed. As a result, the manufacturer cannot efficiently manufacture products, and increase in cost is sometimes caused.

The source of this vicious cycle is that the accuracy of the initial demand prediction is bad. If the accuracy of such a demand prediction is improved, delay of delivery of products and increase in cost can be prevented.

Some methods of predicting demands of products have already been proposed. For example, there is a demand prediction method of predicting demands that takes into account not only the information of placed orders but also inquiry information of which probability of order reception is high (for example, see Patent Literature 1).

Also, there is a demand prediction method of predicting demands that takes into accounts probability of order reception, which is obtained from the amount of error between inquiry information and information of actually received orders, in addition to business-meeting/contact information (inquiry information) (for example, see Patent Literature 2).

### CITATION LIST

### Patent Literature

Patent Literature 1: Japanese Patent Application Laid-Open No. 2006-072590
Patent Literature 2: Japanese Patent Application Laid-Open No. 2001-134643

### SUMMARY OF INVENTION

### Technical Problem

In the above described inventions of Patent Literatures 1 and 2, demands are predicted by taking the current inquiry information into consideration or carrying out appropriate statistical processing; however, accuracy thereof has been still insufficient. Particularly, the attribute of demanders (customers) has not been taken into consideration at all.

It is an object of the present invention to provide a demand prediction system capable of predicting demands at high accuracy while taking into consideration on the attribute of demanders (customers) in view of the above described conventional techniques.

### Solution to Problem

A configuration of the present invention that solves the above described problems is a demand prediction system for predicting demands from customers having a plurality of attributes, wherein

the attribute of the customer is taken into consideration for each of the attributes of the customers to predict the demand of the customer; and

all of the demands obtained by carrying out prediction individually for each of the attributes of the customers are added to predict total demands.

Another configuration of the present invention is

A demand prediction system having:

an inquiry information database unit (21) to which:
inquiry information icL(r) indicating an inquiry date and the number of inquired units of a case in which an inquiry is made by a large-customer dealer and
inquiry information icL(r) indicating an inquiry date and the number of inquired units of a case in which an inquiry is made by a large-customer corporation is input, the inquiry information database unit (21) that chronologically arranges and stores both of the inquiry information idL(r) and icL(r);

an order-reception information database unit (22) to which:
order-reception information idL(o) indicating a shipment date and the number of units to be shipped, the date and the number determined according to an order-received date and a received order of a case in which an order is received from the large-customer dealer,
order-reception information idS(o) indicating a shipment date and the number of units to be shipped, the date and the number determined according to an order-received date and a received order of a case in which an order is received from a small-customer dealer,
order-reception information icL(o) indicating a shipment date and the number of units to be shipped, the date and the number determined according to an order-received date and a received order of a case in which an order is received from the large-customer corporation,
order-reception information icS(o) indicating a shipment date and the number of units to be shipped, the date and the number determined according to an order-received date and a received order of a case in which an order is received from a small-customer corporation is input, the order-reception information database unit (22) that chronologically arranges and stores the order-reception information idL(o), idS(o), icL(o), and icS(o);

an order-reception rate computing unit (31) that:
computes an order-reception rate Rd of the large dealer from the order-reception information idL(o) obtained from the order-reception information database unit (22) and the inquiry information idL(r) obtained from the inquiry information database unit (21) and
computes an order-reception rate Rc of the large corporation from the order-reception information icL(o) obtained from the order-reception information database unit (22) and the inquiry information icL(r) obtained from the inquiry information database unit (21);

a lead-time computing unit (41) that:
computes distribution of lead times LTd of the large-customer dealer from the order-reception information idL(o) obtained from the order-reception information database unit (22) and
computes lead times LTc of the large-customer corporation from the order-reception information icL(o) obtained from the order-reception information database unit (22);

an account-rate computing unit (51) that:
computes account rates Hd of the dealers from the order-reception information idS(o) and the order-reception information idL(o) obtained from the order-reception information database unit (22) and
computes account rates Hc of the corporations from the order-reception information icS(o) and the order-reception information icL(o) obtained from the order-reception information database unit (22); and

a demand prediction computing unit (100) that comprises a dealer demand prediction computing unit (200), a corporation demand prediction computing unit (300), and a totaling unit (400); wherein

the dealer demand prediction computing unit (200) has:
a demand prediction computing unit (201) that obtains the number of the units predicted to be shipped in a time bucket after the point of computation in terms of time by carrying out the computation by using: the number of inquired units in a computation-point time bucket obtained from the inquiry information idL(r) obtained from the inquiry information database unit (21), the order-reception rate Rd obtained from the order-reception rate computing unit (31), and the lead times LTd obtained from the lead-time computing unit (41);
a demand prediction computing unit (202) that obtains the number of the units predicted to be shipped in a time bucket after the point of computation in terms of time by carrying out the computation by using: the number of inquired units in a past time bucket corresponding to the computation-point time bucket obtained from the inquiry information idL(r) obtained from the inquiry information database unit (21), the order-reception rate Rd obtained from the order-reception rate computing unit (31), and the lead times LTd obtained from the lead-time computing unit (41);
a demand prediction computing unit (203) that obtains the number of units predicted to be shipped in a time bucket after the point of computation in terms of time by carrying out the computation by using: the number of the units predicted to be shipped, the number obtained by the demand prediction computing unit (201), the number of the units predicted to be shipped, the number obtained by the demand prediction computing unit (202), the order-reception information idL(o) obtained from the order-reception rate computing unit (31), and the account rates Hd obtained from the account-rate computing unit (51); and
a totaling unit (204) that obtains the number of the units to be shipped to the dealer by adding, for each time bucket, the numbers of the units predicted to be shipped, the numbers computed by the demand prediction computing unit (201), the demand prediction computing unit (202), and the demand prediction computing unit (203);

the corporation demand prediction computing unit (300) has:
a demand prediction computing unit (301) that obtains the number of the units predicted to be shipped in a time bucket after the point of computation in terms of time by carrying out the computation by using: the number of inquired units in a computation-point time bucket obtained from the inquiry information icL(r) obtained from the inquiry information database unit (21), the order-reception rate Rc obtained from the order-reception rate computing unit (31), and the lead times LTc obtained from the lead-time computing unit (41);
a demand prediction computing unit (302) that obtains the number of the units predicted to be shipped in a time bucket after the point of computation in terms of time by carrying out the computation by using: the number of inquired units in a past time bucket corresponding to the computation-point time bucket obtained from the inquiry information icL(r) obtained from the inquiry information database unit (21), the order-reception rate Rc obtained from the order-reception rate computing unit (31), and the lead times LTc obtained from the lead-time computing unit (41); and
a totaling unit (304) that obtains the number of the units to be shipped to the corporation by adding, for each time bucket, the numbers of the units predicted to be shipped, the numbers computed by the demand prediction computing unit (301) and the demand prediction computing unit (302); and

the totaling unit (400) obtains the total number of the units predicted to be shipped by adding, for each time bucket, the number of the units predicted to be shipped to the dealers in each time bucket, the number obtained by the totaling unit (204), and the number of the units predicted to be shipped to the corporations in each time bucket, the number obtained by the totaling unit (304).

### Advantageous Effects of Invention

According to the present invention, demands are predicted by taking customer attributes into consideration; therefore, demand prediction accuracy is improved.

### BRIEF DESCRIPTION OF DRAWINGS

FIG. 1 is a block configuration diagram showing a demand prediction system according to Example of the present invention.

FIG. 2 is a block configuration diagram showing a dealer demand prediction computing unit of Example.

FIG. 3 is a block configuration diagram showing a corporation demand prediction computing unit of Example.

### DESCRIPTION OF EMBODIMENT

Hereinafter, an embodiment of the present invention will be explained in detail based on Example.

### Example

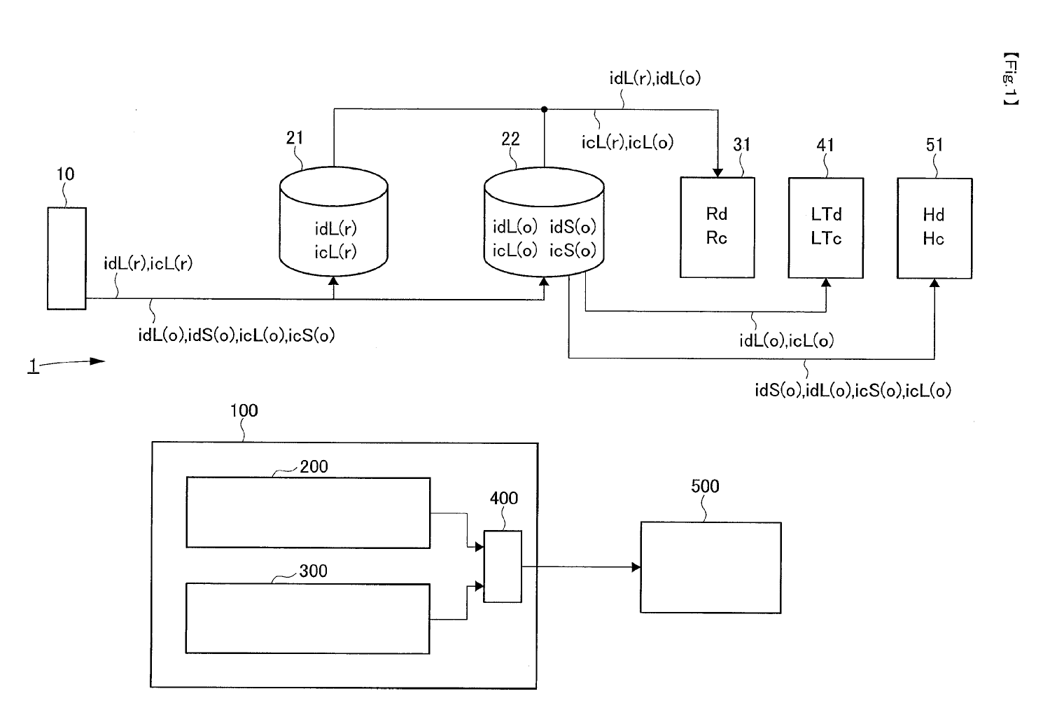

FIG. 1 is a block configuration diagram showing a demand prediction system 1 according to Example 1 of the present invention, which predicts the number of forklift units to be shipped (the number of demanded units).

Inquiry information and order-reception information is input from an input unit 10 of the demand prediction system 1 of the forklifts shown in FIG. 1. Specifically,

(1) when an inquiry is made by a large-customer dealer (a demander who purchases forklifts in a large quantity), inquiry information idL(r) indicating an inquiry date and the number of inquired units is input;
(2) when an inquiry is made by a large-customer corporation (a demander who purchases forklifts in a large quantity), inquiry information icL(r) indicating an inquiry date and the number of inquired units is input;
(3) when an order is received from a large-customer dealer (a demander who purchases forklifts in a large quantity), order-reception information idL(o) indicating a shipment date and the number of units to be shipped “the number of ordered units”) determined according to an order-received date and the received order is input;
(4) when an order is received from a small-customer dealer (a demander who purchases forklifts in a small quantity), order-reception information idS(o) indicating a shipment date and the number of units to be shipped (the number of ordered units) determined according to an order-received date and the received order is input;
(5) when an order is received from a large-customer corporation

(a demander who purchases forklifts in a large quantity), order-reception information icL(o) indicating a shipment date and the number of shipped units (the number of ordered units) determined according to an order-received date and the received order is input; and

(6) when an order is received from a small-customer corporation (a demander who purchases forklifts in a small quantity), order-reception information icS(o) indicating a shipment date and the number of ordered units (the number of ordered units) determined according to an order-received date and the received order is input.

An inquiry information database unit 21 chronologically arranges and stores the inquiry information idL(r) of the large-customer dealer and the inquiry information icL(r) of the large-customer corporation input from the input unit 10 to build an inquiry information database.

An order-reception information database unit 22 chronologically arranges and stores the order-reception information idL(o) of the large-customer dealer, the order-reception information idS(o) of the small-customer dealer, the order-reception information icL(o) of the large-customer corporation, and the order-reception information icS(o) of the small-customer corporation input from the input unit 10 to build an order-reception information database.

An order-reception rate computing unit 31 obtains an order-reception rate Rd of the large-customer dealer by a computation. The order-reception rate Rd refers to a rate at which actually orders have been placed after an inquiry(ies) made from the large-customer dealer.

In the above described computation, specifically, the order-reception rate Rd is obtained by dividing the number of units to be shipped (the number of ordered units) in a certain period (a period from a current point to a past point determined in advance), which has been obtained from the order-reception information idL(o) of the large-customer dealer stored in the order-reception database unit 22, by the number of inquired units in a certain period (a period from a current point to a past point determined in advance), which has been obtained from the inquiry information idL(r) of the large-customer dealer stored in the inquiry information database unit 21.

For example, in a case in which the number of the units inquired by a large-customer dealer is 100 and the number of units to be shipped (the number of ordered units) as a result of an order placed after the inquiry is 44, the order-reception rate Rd is 44%.

The order-reception rate computing unit 31 also obtains an order-reception rate Rc of the large-customer corporation by a computation. The order-reception rate Rc refers to a rate at which actually orders have been placed after an inquiry(ies) made from the large-customer corporation.

In the above described computation, specifically, the order-reception rate Rc is obtained by dividing the number of units to be shipped (the number of ordered units) in a certain period (a period from a current point to a past point determined in advance), which has been obtained from the order-reception information icL(o) of the large-customer corporation stored in the order-reception information database unit 22, by the number of inquired units in a certain period (a period from a current point to a past point determined in advance), which has been obtained from the inquiry information icL(r) of the large-customer corporation stored in the inquiry information database unit 21.

For example, in a case in which the number of the units inquired by a large-customer corporation is 100 and the number of units ordered as a result of an order placed after the inquiry is 44, the order-reception rate Rd is 44%.

A lead-time computing unit 41 obtains “distribution of lead times (LTd), each of which is a period (the number of days) from the order-received date to the shipment date,” of the large-customer dealer from the order-reception information idL(o) of the large-customer dealer stored in the order-reception information database unit 22.

Specifically, the information of a certain period (a period from a current point to a past point determined in advance) is extracted from the order-reception information idL(o) of the large-customer dealer, and the distribution of the periods (lead times) from the order-received dates indicated in the extracted information to the shipment dates determined according to the received order is obtained.

Table 1 shows an example of “the distribution of the lead times (LTd) from the order-received dates to the shipment dates” of the large-customer dealer. In the example of Table 1, the distribution of the lead times (LTd) is obtained for every week.

TABLE 1

| LTd | Rate |
|---|---|
| 1 week | 15% |
| 2 weeks | 45% |
| 3 weeks | 30% |
| 4 weeks | 5% |
| 5 weeks | 5% |

The lead-time computing unit 41 also obtains “distribution of lead times (LTc), each of which is a period (the number of days) from the order-received date to the shipment date,” of the large-customer corporation from the order-reception information icL(o) of the large-customer coporation stored in the order-reception information database unit 22.

Specifically, the information of a certain period (a period from a current point to a past point determined in advance) is extracted from the order-reception information icL(o) of the large-customer corporation, and the distribution of the periods (lead times) from the order-received dates indicated in the extracted information to the shipment dates determined according to the received order is obtained.

Table 2 shows an example of “the distribution of the lead times (LTc) from the order-received dates to the shipment dates” of the large-customer corporation. In the example of Table 2, the distribution of the lead times (LTc) is obtained for every week.

TABLE 2

| LTd | Rate |
|---|---|
| 1 week | 5% |
| 2 weeks | 5% |
| 3 weeks | 30% |
| 4 weeks | 45% |
| 5 weeks | 15% |

Generally, there is a tendency that the “lead times (LTc)” of the large-customer corporation are longer than the “lead times (LTd)” of the large-customer dealer.

In Table 1 and Table 2, “the lead time (LTd or LTc) is 1 week” means that the period from the order-received date to the shipment date is 1 week; and “the lead time (LTd or LTc) is 2 weeks” means that the period from the order-received date to the shipment date is 2 weeks. The lead time (LTd or LTc) of 3 weeks, 4 weeks, or 5 weeks has a similar meaning.

An account rate computing unit 51 obtains an account rate Hd (=“the total number of the units to be shipped to the small-customer dealer in a certain period”÷“the total number of the units to be shipped to the large-customer dealer in the certain period”) of the dealers.

Specifically, the account rate Hd of the dealers is obtained by dividing the total number of the units to be shipped (the total number of the ordered units) in the certain period (the period from the current point to the past point determined in advance), the total number obtained from the order-reception information idS(o) of the small-customer dealer stored in the order-reception information database unit 22, by the total number of the units to be shipped (the total number of the ordered units) in the certain period (the period from the current point to the past point determined in advance), the total number obtained from the order-reception information idL(o) of the large-customer dealer stored in the order-reception information database unit 22.

The account rate computing unit 51 also obtains an account rate Hc (=“the total number of the units to be shipped to the small-customer corporation in a certain period”÷“the total number of the units to be shipped to the large-customer corporation in the certain period”) of the corporations.

Specifically, the account rate Hc of the corporation is obtained by dividing the total number of the units to be shipped (the total number of the ordered units) in the certain period (the period from the current point to the past point determined in advance), the total number obtained from the order-reception information icS(o) of the small-customer corporation stored in the order-reception information database unit 22, by the total number of the units to be shipped (the total number of the ordered units) in the certain period (the period from the current point to the past point determined in advance), the total number obtained from the order-reception information icL(o) of the large-customer corporation stored in the order-reception information database unit 22.

A demand prediction computing unit 100 consists of a dealer demand prediction computing unit 200, a corporation demand prediction computing unit 300, and a totaling unit 400. Details of computing functions and computing operations of the demand prediction computing unit 100 will be described later.

The number of demand-predicted units (the number of units to be shipped) predicted by the demand prediction computing unit 100 is output to an output unit 500 and subjected to display, printing, etc.

The details of the computing functions and the computing operations of the demand prediction computing unit 100 will be explained separately for each of the dealer demand prediction computing unit 200, the corporation demand prediction computing unit 300, and the totaling unit 400.

In the demand prediction computing unit 100, every week, demand prediction computations are carried out at particular time and date (for example, last time and date) of each week, and the demand prediction is carried out while using one week as unit time (time bucket).

Below examples will be explained about a case in which, for example, when the computations are carried out at the last time and date of the third week of May, the computations of carrying out the demand prediction of the number of units to be shipped (the number of ordered units, the number of demanded units) in each of weeks including: the fourth week of May which is a first time bucket in terms of time after the time bucket (the third week of May) including a computation point, the first week of June which is a second time bucket in terms of time after the third week of May, the second week of June which is a third time bucket in terms of time after the third week of May, and the third week of June which is a fourth time bucket in terms of time after the third week of May is carried out.

The time bucket (the third week of May) including the computation point is defined and explained as a “computation-point time bucket”.

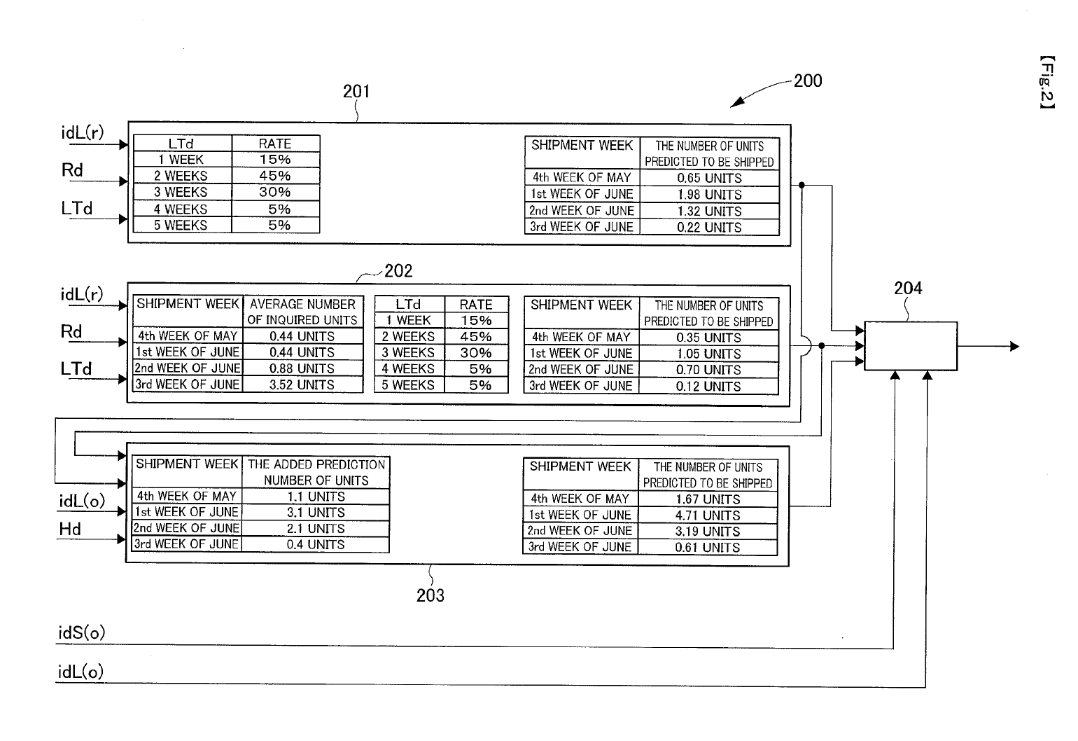

The dealer demand prediction computing unit 200 consists of demand prediction computing units 201, 202, and 203 and a totaling unit 204 as shown in FIG. 2.

The demand prediction computing unit 201 carries out demand prediction computations of large dealers in a case in which there are order-unreceived inquiries.

The demand prediction computing unit 202 carries out demand prediction computations of large dealers in a case in which no order and no inquiry have been received.

The demand prediction computing unit 203 carries out demand prediction computations of small dealers in a case in which no order has been received.

The demand prediction computing unit 201 carries out computations of (1) to (3) shown below.

(1) The inquiry information idL(r) of the large-customer dealer is imported from the inquiry information database unit 21, and the number of inquired units in the third week of May, which is the computation-point time bucket, is obtained. In this case, the number of the inquired units is for example 10.
(2) The order-reception rate Rd of the large-customer dealer is imported from the order-reception rate computing unit 31, and the number of units predicted to be ordered (for example, 4.4 units) is obtained by multiplying the number of inquired units (10 units) obtained in above described (1) by the order-reception rate Rd (for example, 44%).
(3) The distribution (see Table 1) of the lead times (LTd) of the large-customer dealer is imported from the lead-time computing unit 41. Then:
the number of units predicted to be shipped (0.66 units) in the fourth week of May, which is the first time bucket in terms of time after the computation-point time bucket (the third week of May), is obtained by multiplying the number of the units predicted to be ordered (for example, 4.4 units) by the rate (15%) of the case in which the lead time LTd is one week;
the number of units predicted to be shipped (1.98 units) in the first week of June, which is the second time bucket in terms of time after the computation-point time bucket (the third week of May), is obtained by multiplying the number of the units predicted to be ordered (for example, 4.4 units) by the rate (45%) of the case in which the lead time LTd is two weeks;
the number of units predicted to be shipped (1.32 units) in the second week of June, which is the third time bucket in terms of time after the computation-point time bucket (the third week of May), is obtained by multiplying the number of the units predicted to be ordered (for example, 4.4 units) by the rate (30%) of the case in which the lead time LTd is three weeks; and
the number of units predicted to be shipped (0.22 units) in the third week of June, which is the fourth time bucket in terms of time after the computation-point time bucket (the third week of May), is obtained by multiplying the number of the units predicted to be ordered (for example, 4.4 units) by the rate (5%) of the case in which the lead time LTd is four weeks.

Next Table 3 shows the numbers the units predicted to be shipped in each of shipment weeks (each of the time buckets) obtained by the demand prediction computing unit 201.

TABLE 3

| | The number of units |
|---|---|
| Shipment Week | predicted to be shipped |
| The fourth week of May | 0.66 units |
| The first week of June | 1.98 units |
| The second week of June | 1.32 units |
| The third week of June | 0.22 units |

The demand prediction computing unit 202 carries out computations of (11) to (13) shown below.

(11) The inquiry information idL(r) of the large-customer dealer is imported from the inquiry information database unit 21,
the average number of inquired units (for example, 0.44 units) of the number of units inquired in the fourth week of May, which is the first time bucket in terms of time after the third week of May which is the computation-point time bucket, in the past several years is obtained;
the average number of inquired units (for example, 0.44 units) of the number of units inquired in the first week of June, which is the second time bucket in terms of time after the third week of May which is the computation-point time bucket, in the past several years is obtained;
the average number of inquired units (for example, 0.88 units) of the number of units inquired in the second week of June, which is the third time bucket in terms of time after the third week of May which is the computation-point time bucket, in the past several years is obtained; and
the average number of inquired units (for example, 3.52 units) of the number of units inquired in the third week of June, which is the fourth time bucket in terms of time after the third week of May which is the computation-point time bucket, in the past several years is obtained.

Then, the above described four average numbers of the inquired units are added to obtain the added number of the inquired units (for example, 5.28 units).

In this manner, although there is actually no inquiry, it is assumed that there has been inquiries in the computation-point time bucket (the third week of May) by the added number of the inquired units (for example, 5.28 units) obtained by referencing the number of the inquired units in the past several years.

Next Table 4 shows the average number of the inquired units of each shipment week (each time bucket) obtained by the demand prediction computing unit.

TABLE 4

| | The average number of |
|---|---|
| Shipment Week | inquired units |
| The fourth week of May | 0.44 units |
| The first week of June | 0.44 units |
| The second week of June | 0.88 units |
| The third week of June | 3.52 units |

(12) The order-reception rate Rd (for example, 44%) of the large-customer dealer is imported from the order-reception rate computing unit 31, and the number of units predicted to be ordered (for example, 2.32 units) is obtained by multiplying the added number of the inquired units (for example, 5.28 units) obtained in above described (11) by the order-reception rate Rd (for example, 44%).
(13) The distribution of the lead times (LTd) of the large-customer dealer (see Table 1) is imported from the lead-time computing unit 41. Then,
the number of units predicted to be shipped (0.35 units) in the fourth week of May, which is the first time bucket in terms of time after the computation-point time bucket (the third week of May), is obtained by multiplying the number of the units predicted to be ordered (for example, 2.32 units) by the rate (15%) of the case in which the lead time LTd is one week;
the number of units predicted to be shipped (1.05 units) in the first week of June, which is the second time bucket in terms of time after the computation-point time bucket (the third week of May), is obtained by multiplying the number of the units predicted to be ordered (for example, 2.32 units) by the rate (45%) of the case in which the lead time LTd is two weeks;
the number of units predicted to be shipped (0.70 units) in the second week of June, which is the third time bucket in terms of time after the computation-point time bucket (the third week of May), is obtained by multiplying the number of the units predicted to be ordered (for example, 2.32 units) by the rate (30%) of the case in which the lead time LTd is three weeks; and
the number of units predicted to be shipped (0.12 units) in the third week of June, which is the fourth time bucket in terms of time after the computation-point time bucket (the third week of May), is obtained by multiplying the number of the units predicted to be ordered (for example, 2.32 units) by the rate (5%) of the case in which the lead time LTd is four weeks.

Next Table 5 shows the number of the units predicted to be shipped in each shipment week (each time bucket) obtained by the demand prediction computing unit 202.

TABLE 5

| | The number of units |
|---|---|
| Shipment Week | predicted to be shipped |
| The fourth week of May | 0.35 units |
| The first week of June | 1.05 units |
| The second week of June | 0.70 units |
| The third week of June | 0.12 units |

The demand prediction computing unit 203 carries out computations of (21) to (25) shown below.

(21) The order-reception information idL(o) of the large-customer dealer is imported from the order-reception information database unit 22;
the number of the ordered units of the large-customer dealer in the fourth week of May, which is the first time bucket in terms of time after the third week of May which is the computation-point time bucket, is imported;
the number of the ordered units of the large-customer dealer in the first week of June, which is the second time bucket in terms of time after the third week of May which is the computation-point time bucket, is imported;
the number of the ordered units of the large-customer dealer in the second week of June, which is the third time bucket in terms of time after the third week of May which is the computation-point time bucket, is imported; and
the number of the ordered units of the large-customer dealer in the third week of June, which is the fourth time bucket in terms of time after the third week of May which is the computation-point time bucket, is imported.
   (22) The below-described numbers of the units predicted to be shipped obtained by the demand prediction computing unit 201 are imported from the demand prediction computing unit 201.
The number of the units predicted to be shipped (0.66 units) in the fourth week of May, which is the first time bucket in terms of time after the computation-point time bucket (the third week of May);
The number of the units predicted to be shipped (1.98 units) in the first week of June, which is the second time bucket in terms of time after the computation-point time bucket (the third week of May);
The number of the units predicted to be shipped (1.32 units) in the second week of June, which is the third time bucket in terms of time after the computation-point time bucket (the third week of May); and
The number of the units predicted to be shipped (0.22 units) in the third week of June, which is the fourth time bucket in terms of time after the computation-point time bucket (the third week of May).
   (23) The below-described numbers of the units predicted to be shipped obtained by the demand prediction computing unit 202 are imported from the demand prediction computing unit 202.
The number of the units predicted to be shipped (0.35 units) in the fourth week of May, which is the first time bucket in terms of time after the computation-point time bucket (the third week of May);
The number of the units predicted to be shipped (1.05 units) in the first week of June, which is the second time bucket in terms of time after the computation-point time bucket (the third week of May);
The number of the units predicted to be shipped (0.70 units) in the second week of June, which is the third time bucket in terms of time after the computation-point time bucket (the third week of May); and
The number of the units predicted to be shipped (0.12 units) in the third week of June, which is the fourth time bucket in terms of time after the computation-point time bucket (the third week of May).
   (24) By using the numbers of the units imported in above described (21) to (23),
the added prediction number of units (for example, 1.1 units) obtained by adding the numbers of the units in the fourth week of May imported in above described (21) to (23) is obtained for the fourth week of May, which is the first time bucket in terms of time after the computation-point time bucket (the third week of May);
the added prediction number of units (for example, 3.1 units) obtained by adding the numbers of the units in the first week of June imported in above described (21) to (23) is obtained for the first week of June, which is the second time bucket in terms of time after the computation-point time bucket (the third week of May);
the added prediction number of units (for example, 2.1 units) obtained by adding the numbers of the units in the second week of June imported in above described (21) to (23) is obtained for the second week of June, which is the third time bucket in terms of time after the computation-point time bucket (the third week of May); and
the added prediction number of units (for example, 0.4 units) obtained by adding the numbers of the units in the third week of June imported in above described (21) to (23) is obtained for the third week of June, which is the fourth time bucket in terms of time after the computation-point time bucket (the third week of May).

Next Table 6 shows the added prediction numbers of the units obtained by adding the numbers of the units imported in above described (21) to (23) for each shipment week (each time bucket).

TABLE 6

| | The added prediction |
|---|---|
| Shipment Week | number of units |
| The fourth week of May | 1.1 units |
| The first week of June | 3.1 units |
| The second week of June | 2.1 units |
| The third week of June | 0.4 units |

(25) The account rate Hd (for example, 1.52) of the dealer is imported from the account-rate computing unit 51;
the number of the units predicted to be shipped (for example, 1.67 units) in the fourth week of May, which is the first time bucket in terms of time after the computation-point time bucket (the third week of May), is obtained by multiplying the added prediction number of the units (1.1 units) obtained by above described (24) by the account rate Hd (for example, 1.52);
the number of the units predicted to be shipped (for example, 4.71 units) in the first week of June, which is the second time bucket in terms of time after the computation-point time bucket (the third week of May), is obtained by multiplying the added prediction number of the units (3.1 units) obtained by above described (24) by the account rate Hd (for example, 1.52);
the number of the units predicted to be shipped (for example, 3.19 units) in the second week of June, which is the third time bucket in terms of time after the computation-point time bucket (the third week of May), is obtained by multiplying the added prediction number of the units (2.1 units) obtained by above described (24) by the account rate lid (for example, 1.52); and
the number of the units predicted to be shipped (for example, 0.61 units) in the third week of June, which is the fourth time bucket in terms of time after the computation-point time bucket (the third week of May), is obtained by multiplying the added prediction number of the units (0.4 units) obtained by above described (24) by the account rate Hd (for example, 1.52).

Next Table 7 shows the numbers of the units predicted to be shipped in each shipment week (each time bucket), wherein the numbers are obtained by the computations of above described (25) for each shipment week (each time bucket).

TABLE 7

| | The number of units |
|---|---|
| Shipment Week | predicted to be shipped |
| The fourth week of May | 1.67 units |
| The first week of June | 4.71 units |
| The second week of June | 3.19 units |
| The third week of June | 0.61 units |

The totaling unit 204 imports the number of the units to be shipped according to the order-reception information idL(o) of the large-customer dealer and the number of the units to be shipped according to the order-reception information idS(o) of the small-customer dealer from the order-reception database unit 22 and imports the numbers of the units predicted to be shipped, the numbers computed by the demand prediction computing units 201, 202, and 203.

Then,
with respect to the fourth week of May, which is the first time bucket in terms of time after the computation-point time bucket (the third week of May), the number of the units predicted to be shipped to the dealers is obtained by adding: the number of the units to be shipped according to the order-reception information idL(o) of the large-customer dealer, the number of the units to be shipped according to the order-reception information idS(o) of the small-customer dealer, and the numbers of the units predicted to be shipped in the fourth week of May, the numbers computed by the demand prediction computing units 201, 202, and 203;
with respect to the first week of June, which is the second time bucket in terms of time after the computation-point time bucket (the third week of May), the number of the units predicted to be shipped to the dealers is obtained by adding: the number of the units to be shipped according to the order-reception information idL(o) of the large-customer dealer, the number of the units to be shipped according to the order-reception information idS(o) of the small-customer dealer, and the numbers of the units predicted to be shipped in the first week of June, the numbers computed by the demand prediction computing units 201, 202, and 203;
with respect to the second week of June, which is the third time bucket in terms of time after the computation-point time bucket (the third week of May), the number of the units predicted to be shipped to the dealers is obtained by adding: the number of the units to be shipped according to the order-reception information idL(o) of the large-customer dealer, the number of the units to be shipped according to the order-reception information idS(o) of the small-customer dealer, and the numbers of the units predicted to be shipped in the second week of June, the numbers computed by the demand prediction computing units 201, 202, and 203; and
with respect to the third week of June, which is the fourth time bucket in terms of time after the computation-point time bucket (the third week of May), the number of the units predicted to be shipped to the dealers is obtained by adding: the number of the units to be shipped according to the order-reception information idL(o) of the large-customer dealer, the number of the units to be shipped according to the order-reception information idS(o) of the small-customer dealer, and the numbers of the units predicted to be shipped in the third week of June, the numbers computed by the demand prediction computing units 201, 202, and 203.

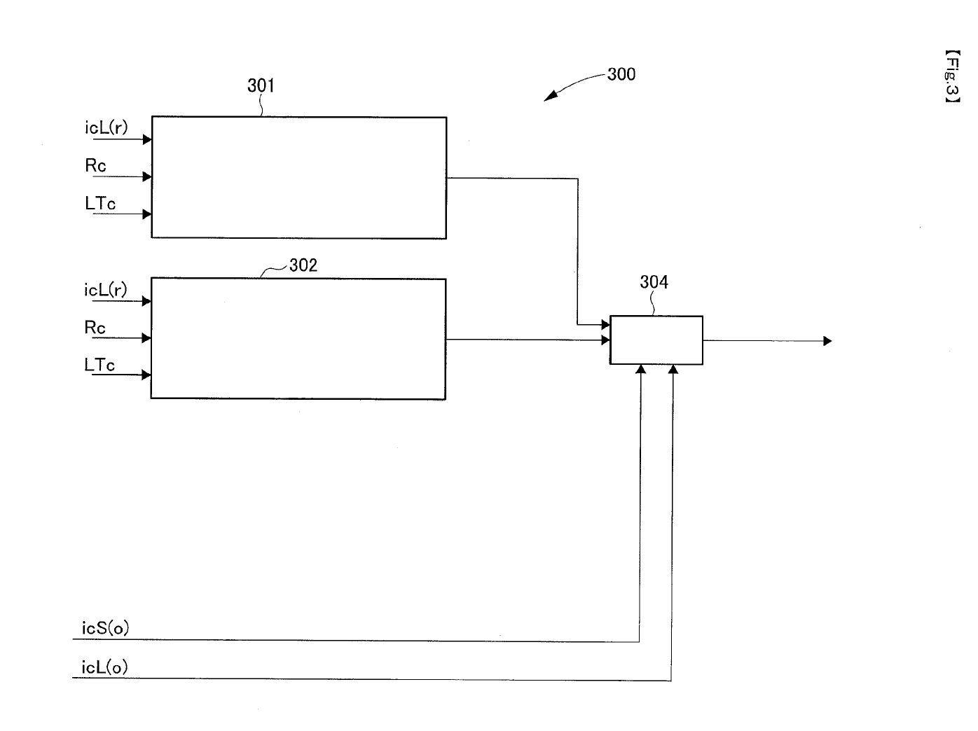

As shown in FIG. 3, the corporation demand prediction computing unit 300 consists of demand prediction computing units 301 and 302 and a totaling unit 304.

The demand prediction computing unit 301 carries out demand prediction computations of large corporations in a case in which there are order-unreceived inquiries.

The demand prediction computing unit 302 carries out demand prediction computations of large corporations in a case in which no order and no inquiry have been received.

The demand prediction computing unit 301 carries out computations similar to those of the demand prediction computing unit 201. However,
instead of the inquiry information idL(r) of the large-customer dealer, the inquiry information icL(r) of the large-customer corporation is used;
instead of the order-reception rate Rd of the large-customer dealer, the order-reception rate Rc of the large-customer corporation is used; and
instead of the lead times LTd of the large-customer dealer, the lead times LTc of the large-customer corporation are used.

As a computation method, the computation method same as that carried out in the demand prediction computing unit 201 is used to obtain the number of the units predicted to be shipped in each shipment week (bucket time).

The demand prediction computing unit 302 carries out computations similar to those of the demand prediction computing unit 202. However,
instead of the inquiry information idL(r) of the large-customer dealer, the inquiry information icL(r) of the large-customer corporation is used;
instead of the order-reception rate Rd of the large-customer dealer, the order-reception rate Rc of the large-customer corporation is used; and
instead of the lead times LTd of the large-customer dealer, the lead times LTc of the large-customer corporation are used.

As a computation method, the computation method same as that carried out in the demand prediction computing unit 202 is used to obtain the number of the units predicted to be shipped in each shipment week (bucket time).

The totaling unit 304 imports the number of the units to be shipped according to the order-reception information icL(o) of the large-customer corporation and the number of the units to be shipped according to the order-reception information icS(o) of the small-customer corporation from the order-reception database unit 22 and imports the numbers of the units predicted to be shipped, the numbers computed by the demand prediction computing units 301 and 302.

Then,
with respect to the fourth week of May, which is the first time bucket in terms of time after the computation-point time bucket (the third week of May), the number of the units predicted to be shipped to the corporations is obtained by adding: the number of the units to be shipped according to the order-reception information icL(o) of the large-customer corporation, the number of the units to be shipped according to the order-reception information icS(a) of the small-customer corporation, and the numbers of the units predicted to be shipped, the numbers computed by the demand prediction computing units 301 and 302;
with respect to the first week of June, which is the second time bucket in terms of time after the computation-point time bucket (the third week of May), the number of the units predicted to be shipped to the corporations is obtained by adding: the number of the units to be shipped according to the order-reception information icL(o) of the large-customer corporation, the number of the units to be shipped according to the order-reception information icS(o) of the small-customer corporation, and the numbers of the units predicted to be shipped, the numbers computed by the demand prediction computing units 301 and 302;
with respect to the second week of June, which is the third time bucket in terms of time after the computation-point time bucket (the third week of May), the number of the units predicted to be shipped to the corporations is obtained by adding: the number of the units to be shipped according to the order-reception information icL(o) of the large-customer corporation, the number of the units to be shipped according to the order-reception information icS(o) of the small-customer corporation, and the numbers of the units predicted to be shipped, the numbers computed by the demand prediction computing units 301 and 302; and
with respect to the third week of June, which is the fourth time bucket in terms of time after the computation-point time bucket (the third week of May), the number of the units predicted to be shipped to the corporations is obtained by adding: the number of the units to be shipped according to the order-reception information icL(o) of the large-customer corporation, the number of the units to be shipped according to the order-reception information icS(o) of the small-customer corporation, and the numbers of the units predicted to be shipped, the numbers computed by the demand prediction computing units 301 and 302.

The totaling unit 400 imports the number of the units predicted to be shipped, the number obtained by the dealer demand prediction computing unit 200, and the number of the units predicted to be shipped, the number obtained by the corporation demand prediction computing unit 300.

Then,
with respect to the fourth week of May, which is the first time bucket in terms of time after the computation-point time bucket (the third week of May), the total number of the units predicted to be shipped in the fourth week of May is obtained by adding the number of the units predicted to be shipped, the number obtained by the dealer demand prediction computing unit 200, and the number of the units predicted to be shipped, the number obtained by the corporation demand prediction computing unit 300;
with respect to the first week of June, which is the second time bucket in terms of time after the computation-point time bucket (the third week of May), the total number of the units predicted to be shipped in the first week of June is obtained by adding the number of the units predicted to be shipped, the number obtained by the dealer demand prediction computing unit 200, and the number of the units predicted to be shipped, the number obtained by the corporation demand prediction computing unit 300;
with respect to the second week of June, which is the third time bucket in terms of time after the computation-point time bucket (the third week of May), the total number of the units predicted to be shipped in the second week of June is obtained by adding the number of the units predicted to be shipped, the number obtained by the dealer demand prediction computing unit 200, and the number of the units predicted to be shipped, the number obtained by the corporation demand prediction computing unit 300; and
with respect to the third week of June, which is the fourth time bucket in terms of time after the computation-point time bucket (the third week of May), the total number of the units predicted to be shipped in the third week of June is obtained by adding the number of the units predicted to be shipped, the number obtained by the dealer demand prediction computing unit 200, and the number of the units predicted to be shipped, the number obtained by the corporation demand prediction computing unit 300.

In accordance with needs, the output unit 500 carries out displaying, printing, or data output of: the total number of the units predicted to be shipped in the fourth week of May, the total number of the units predicted to be shipped in the first week of June, the total number of the units predicted to be shipped in the second week of June, and the total number of the units predicted to be shipped in the third week of June.

In this manner, in the present embodiment, the attribute of the customers such as the attribute of the customers if it is a dealer or a corporation or if it is a large customer or a small customer is taken into consideration to predict the number of the units predicted to be shipped; therefore, the number of the units to be shipped can be predicted at good accuracy.

### INDUSTRIAL APPLICABILITY

The present invention can be applied not only to prediction of the number of forklift units to be shipped (the number of demanded units), but also to demand prediction while taking into consideration the attributes of customers in:
a project including the customer for which prediction accuracy is high and the customer for which prediction accuracy is low; and
a project including a customer for which further information can be obtained and the customer for which future information cannot be obtained.

### REFERENCE SIGNS LIST

10 INPUT UNIT
21 INQUIRY INFORMATION DATABASE UNIT
22 ORDER-RECEPTION INFORMATION DATABASE UNIT
31 ORDER-RECEPTION RATE COMPUTING UNIT
41 LEAD-TIME COMPUTING UNIT
51 ACCOUNT-RATE COMPUTING UNIT
100 DEMAND PREDICTION COMPUTING UNIT
200 DEALER DEMAND PREDICTION COMPUTING UNIT
201, 202, 203 DEMAND PREDICTION COMPUTING UNIT
204 TOTALING UNIT
300 CORPORATION DEMAND PREDICTION COMPUTING UNIT
301, 302 DEMAND PREDICTION COMPUTING UNIT
304 TOTALING UNIT
400 TOTALING UNIT
500 OUTPUT UNIT

1. A demand prediction system for predicting demands from customers having a plurality of attributes, wherein
the attribute of the customer is taken into consideration for each of the attributes of the customers to predict the demand of the customer; and
all of the demands obtained by carrying out prediction individually for each of the attributes of the customers are added to predict total demands.

2. A demand prediction system comprising:
an inquiry information database unit (21) to which:
inquiry information idL(r) indicating an inquiry date and the number of inquired units of a case in which an inquiry is made by a large-customer dealer and
inquiry information icL(r) indicating an inquiry date and the number of inquired units of a case in which an inquiry is made by a large-customer corporation is input, the inquiry information database unit (21) that chronologically arranges and stores both of the inquiry information idL(r) and icL(r);
an order-reception information database unit (22) to which:
order-reception information idL(o) indicating a shipment date and the number of units to be shipped, the date and the number determined according to an order-received date and a received order of a case in which an order is received from the large-customer dealer,
order-reception information idS(o) indicating a shipment date and the number of units to be shipped, the date and the number determined according to an order-received date and a received order of a case in which an order is received from a small-customer dealer,
order-reception information icL(o) indicating a shipment date and the number of units to be shipped, the date and the number determined according to an order-received date and a received order of a case in which an order is received from the large-customer corporation,
order-reception information icS(o) indicating a shipment date and the number of units to be shipped, the date and the number determined according to an order-received date and a received order of a case in which an order is received from a small-customer corporation is input, the order-reception information database unit (22) that chronologically arranges and stores the order-reception information idL(o), idS(o), icL(o), and icS(o);
an order-reception rate computing unit (31) that:
computes an order-reception rate Rd of the large dealer from the order-reception information idL(o) obtained from the order-reception information database unit (22) and the inquiry information idL(r) obtained from the inquiry information database unit (21) and
computes an order-reception rate Rc of the large corporation from the order-reception information icL(o) obtained from the order-reception information database unit (22) and the inquiry information icL(r) obtained from the inquiry information database unit (21);
a lead-time computing unit (41) that:
computes distribution of lead times LTd of the large-customer dealer from the order-reception information idL(o) obtained from the order-reception information database unit (22) and computes lead times LTc of the large-customer
corporation from the order-reception information icL(o) obtained from the order-reception information database unit (22);
an account-rate computing unit (51) that:
computes account rates Hd of the dealers from the order-reception information idL(o) and the order-reception information idL(o) obtained from the order-reception information database unit (22) and
computes account rates Hc of the corporations from the order-reception information icS(o) and the order-reception information icL(o) obtained from the order-reception information database unit (22); and
a demand prediction computing unit (100) that comprises a dealer demand prediction computing unit (200), a corporation demand prediction computing unit (300), and a totaling unit (400); wherein
the dealer demand prediction computing unit (200) has:
a demand prediction computing unit (201) that obtains the number of the units predicted to be shipped in a time bucket after the point of computation in terms of time by carrying out the computation by using: the number of inquired units in a computation-point time bucket obtained from the inquiry information idL(r) obtained from the inquiry information database unit (21), the order-reception rate Rd obtained from the order-reception rate computing unit (31), and the lead times LTd obtained from the lead-time computing unit (41);
a demand prediction computing unit (202) that obtains the number of the units predicted to be shipped in a time bucket after the point of computation in terms of time by carrying out the computation by using: the number of inquired units in a past time bucket corresponding to the computation-point time bucket obtained from the inquiry information idL(r) obtained from the inquiry information database unit (21), the order-reception rate Rd obtained from the order-reception rate computing unit (31), and the lead times LTd obtained from the lead-time computing unit (41);
a demand prediction computing unit (203) that obtains the number of units predicted to be shipped in a time bucket after the point of computation in terms of time by carrying out the computation by using: the number of the units predicted to be shipped, the number obtained by the demand prediction computing unit (201), the number of the units predicted to be shipped, the number obtained by the demand prediction computing unit (202), the order-reception information idL(o) obtained from the order-reception rate computing unit (31), and the account rates Hd obtained from the account-rate computing unit (51); and
a totaling unit (204) that obtains the number of the units to be shipped to the dealer by adding, for each time bucket, the numbers of the units predicted to be shipped, the numbers computed by the demand prediction computing unit (201), the demand prediction computing unit (202), and the demand prediction computing unit (203);
the corporation demand prediction computing unit (300) has:
a demand prediction computing unit (301) that obtains the number of the units predicted to be shipped in a time bucket after the point of computation in terms of time by carrying out the computation by using: the number of inquired units in a computation-point time bucket obtained from the inquiry information icL(r) obtained from the inquiry information database unit (21), the order-reception rate Rc obtained from the order-reception rate computing unit (31), and the lead times LTc obtained from the lead-time computing unit (41);
a demand prediction computing unit (302) that obtains the number of the units predicted to be shipped in a time bucket after the point of computation in terms of time by carrying out the computation by using: the number of inquired units in a past time bucket corresponding to the computation-point time bucket obtained from the inquiry information icL(r) obtained from the inquiry information database unit (21), the order-reception rate Rc obtained from the order-reception rate computing unit (31), and the lead times LTc obtained from the lead-time computing unit (41); and
a totaling unit (304) that obtains the number of the units to be shipped to the corporation by adding, for each time bucket, the numbers of the units predicted to be shipped, the numbers computed by the demand prediction computing unit (301) and the demand prediction computing unit (302); and
the totaling unit (400) obtains the total number of the units predicted to be shipped by adding, for each time bucket, the number of the units predicted to be shipped to the dealers in each time bucket, the number obtained by the totaling unit (204), and the number of the units predicted to be shipped to the corporations in each time bucket, the number obtained by the totaling unit (304).
